(19) United States
(12) Patent Application Publication
(10) Pub. No.: US 2016/0101597 A1
(43) Pub. Date: Apr. 14, 2016

(54) DIMENSIONALLY STABLE LINOLEUM BASED SURFACE COVERINGS

(71) Applicant: ARMSTRONG WORLD INDUSTRIES, INC., Lancaster, PA (US)

(72) Inventor: Mary Kate Davies, Stevens, PA (US)

(21) Appl. No.: 14/714,313

(22) Filed: May 17, 2015

Related U.S. Application Data
(60) Provisional application No. 62/062,477, filed on Oct. 10, 2014.

(51) Int. Cl. B32B 9/02; B32B 5/02; B32B 9/04

(52) U.S. Cl. CPC B32B 9/02; B32B 9/04; B32B 5/024; B32B 5/026; B32B 2419/04; B32B 2264/06; B32B 2264/10; B32B 2255/00; B32B 2307/3065; B32B 2307/734

(57) ABSTRACT

Described herein are surface coverings comprising a carrier, a first linoleum composition comprising a first inorganic filler, a first organic filler and linoleum cement, and a second linoleum composition comprising a second inorganic filler, a second organic filler and linoleum cement. Methods of making and using these surface coverings are also described herein.

### CROSS-REFERENCE TO RELATED APPLICATIONS

This application claims the benefit of U.S. Provisional Patent Application No. 62/062,477 filed on Oct. 10, 2014. The disclosure of the above application is incorporated herein by reference.

### FIELD OF THE DISCLOSURE

The present disclosure relates to surface coverings having improved dimensional stability.

### BACKGROUND

Flooring panels are used in a variety of applications to create aesthetically pleasing and structurally sound room environments. Flooring panels may include linoleum based materials. However, these linoleum based products often suffer from unwanted curling and surface imperfections.

Thus, there remains a need for building panels that provide a combination of dimensional stability and acceptable aesthetics. Embodiments of the present invention are directed to meeting these needs.

### SUMMARY

In some embodiments, the present invention provides a surface covering comprising: a carrier; a first linoleum composition adjacent to the carrier comprising: linoleum cement; a first organic filler; and a first inorganic filler; and a second linoleum composition comprising: linoleum cement; a second organic filler; and a second inorganic filler; wherein the ratio of linoleum cement to the second inorganic filler in the second linoleum composition is from about 1.75:1 to about 3.5:1; and wherein the weight ratio of organic filler in the second linoleum composition to organic filler in the first linoleum composition is greater than 1.5:1.

Other embodiments provide a surface covering comprising: a carrier; a first linoleum composition adjacent to the carrier comprising: linoleum cement; a first organic filler; and a first inorganic filler; and a second linoleum composition comprising: linoleum cement; a second organic filler; and a second inorganic filler; wherein the second organic filler comprises particles having a particle size distribution wherein 40 to 90% of the particles are <160 μm and 10 to 50% of the particles are <80 μm; and wherein the weight ratio of organic filler in the second linoleum composition to organic filler in the first linoleum composition is greater than 1.5:1.

Further embodiments provide a surface covering comprising: a carrier; a first linoleum composition adjacent to the carrier comprising: linoleum cement; a first organic filler; and a first inorganic filler; and a second linoleum composition comprising: linoleum cement; a second organic filler; and a second inorganic filler; wherein the weight ratio of organic filler in the second linoleum composition to organic filler in the first linoleum composition is greater than 1.5:1; and wherein the weight ratio of linoleum cement in the first linoleum composition to linoleum cement in the second linoleum composition is greater than 1.1:1.

### DETAILED DESCRIPTION

In some embodiments, the present invention provides a surface covering comprising: a carrier; a first linoleum composition adjacent to the carrier comprising: linoleum cement; a first organic filler; and a first inorganic filler; and a second linoleum composition comprising: linoleum cement; a second organic filler; and a second inorganic filler; wherein the ratio of linoleum cement to the second inorganic filler in the second linoleum composition is from about 1.75:1 to about 3.5:1; and wherein the weight ratio of organic filler in the second linoleum composition to organic filler in the first linoleum composition is greater than 1.5:1.

In some embodiments, the surface coverings of the present invention comprise a linoleum core. In some embodiments, the linoleum core comprises a first linoleum layer and a second linoleum layer. In some embodiments, the first linoleum layer comprises a first linoleum composition. In some embodiments, the second linoleum layer comprises a second linoleum composition. In some embodiments, the first linoleum layer comprises a first linoleum composition; and the second linoleum layer comprises a second linoleum composition.

Other embodiments provide a surface covering comprising: a carrier; a first linoleum composition adjacent to the carrier comprising: linoleum cement; a first organic filler; and a first inorganic filler; and a second linoleum composition comprising: linoleum cement; a second organic filler; and a second inorganic filler; wherein the second organic filler comprises particles having a particle size distribution wherein 40 to 90% of the particles are <160 μm and 10 to 50% of the particles are <80 μm; and wherein the weight ratio of organic filler in the second linoleum composition to organic filler in the first linoleum composition is greater than 1.5:1.

Further embodiments provide a surface covering comprising: a carrier; a first linoleum composition adjacent to the carrier comprising: linoleum cement; a first organic filler; and a first inorganic filler; and a second linoleum composition comprising: linoleum cement; a second organic filler; and a second inorganic filler; wherein the weight ratio of organic filler in the second linoleum composition to organic filler in the first linoleum composition is greater than 1.5:1; and wherein the weight ratio of linoleum cement in the first linoleum composition to linoleum cement in the second linoleum composition is greater than 1.1:1.

Some embodiments provide that the overall thickness of the surface covering may be varied similarly to conventional floor-coverings with smaller thicknesses e.g. 2 mm being used for lighter wear applications and greater thicknesses such as 2.5 mm and 3.2 mm being used for more critical applications. Some embodiments provide that the surface covering can have overall thickness of from 1 mm to 6 mm; alternatively from 1.5 mm to 4 mm. For some embodiments, the surface covering may be used as a floor covering and have a total thickness of about 1 mm to about 6 mm; alternatively from about 2 mm to about 4 mm.

In some embodiments, the carrier enhances mechanical integrity by acting as a backbone to the surface covering. The carrier may have a first side and a second side—the first side facing toward a subfloor and the second side facing towards a building space or room environment.

In some embodiments, the carrier comprises a binder and a fibrous material. In some embodiments, the fibrous material may be woven or knitted. In some embodiments, the binder may be present in an amount ranging from about 0 wt. % to about 40 wt. % based on the weight of the carrier. In other embodiments, the binder may be present in an amount ranging from about 1 wt. % to about 30 wt. % based on the weight of the carrier.

According to some embodiments, the fibrous material may be selected from a synthetic fiber, a cellulosic fiber, a natural fiber, a synthetic fabric, and a combination of two or more thereof.

In some embodiments, the synthetic fiber may be selected from a polyester (e.g. polyethylene terepthalate), a polyolefin (e.g. polypropylene), polytetrafluoroethylene, polyacrlyonitrile, a polyamide (e.g. nylon), polyacrylate, fiberglass, etc., and a combination of two or more thereof. In some embodiments, the cellulosic fiber and natural fiber may be selected from cotton, jute, viscose, kraft paper, rayon, sisal, and a combination of two or more thereof. Some embodiments provide that the carrier may comprise a material selected from: jute fabric; a mixed fabric of natural fibers; carbon fibers; aramid fibers; quartz fibers; alumina fibers; silicon carbide fibers; and a combination of two or more thereof.

According to some embodiments, the binder may comprise a thermoplastic resin or a thermoset resin that is selected from: an epoxy, a polyurethane, an acrylic latex, a phenolic resin, polyvinyl alcohol, a carbohydrate polymer (e.g. starch), a cellulosic resin, a polyacrylamide, urea-formaldehyde, a melamine resin (e.g. melamine-formaldehyde, melamine-phenol-formaldehyde copolymer), an acrylic copolymer, styrene butadiene rubber, and a combination of two or more thereof. In some embodiments the binder may include one or more resins derived from the following monomers vinyl acetate, vinyl propionate, vinyl butyrate, ethylene, vinyl chloride, vinylidine chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methylacrylate, styrene, butadiene, urethane, epoxy, melamine, and an ester.

In some embodiments, the carrier comprises polyethylene terephthalate. In some embodiments, the carrier comprises polyethylene terephthalate and fiberglass.

Some embodiments provide that the carrier is more or less an open structure and/or substantially porous material so as to facilitate penetration of the first linoleum composition through the carrier. In some embodiments, the carrier may be provided with an adhesive coating (e.g. an adhesion promoter). In some embodiments, the adhesive coating comprises a natural drying oil (e.g. linseed oil or soya oil) or a synthetic material (e.g. acrylic, styrene butadiene rubber or similar) in order to enhance bonding of the first linoleum composition to the carrier.

In some embodiments, the carrier comprises a matrix. Some embodiments provide that the matrix is comprised of first strands and second strands, wherein each of the first and second strands are made of a fibrous material. In some embodiments, the first strands comprise a plurality of micro-strands that are oriented parallel to one another and face a first direction. In other embodiments, the second strands comprise a plurality of micro-strands that are oriented parallel to one another and face a second direction. In some embodiments, the first and the second direction may be offset by angle ranging from about 10° to about 90°. According to some embodiments, the angle offset between the first strands and the second strands create an intersecting grid of first stands and second stands. In some embodiments, the carrier comprises first, second, third, fourth, fifth, sixth, etc., strands—each of which may be oriented by an offset angle.

In some embodiments, the first strands may be separated from one another by a first distance—i.e. “length.” In another embodiment, the second strands may be separated from one another by a second distance—i.e. “width.” In some embodiments, the length may range from about 0.1 mm to about 5 mm. In some embodiments, the length may range from about 0.5 mm to about 2 mm. In some embodiments, the length may be about 1 mm. In some embodiments, the width may range from about 0.1 mm to about 5 mm. In some embodiments, the width may range from about 0.5 mm to about 2 mm. In some embodiments, the width may be about 1 mm. According to some embodiments the space between adjacent first strands and space between adjacent second strands creates voids in the carrier. In some embodiments, the dimensions of each void are directly related to the length and width between respective first and second adjacent strands, as well as the offset angle of intersecting first and second strands.

In some embodiments, the first strands are separated by a length of about 1 mm, the second strands are separated by a width of about 1 mm, and the first and second strands have an offset angle of about 90°—thereby resulting in substantially square voids having a length and a width of about 1 mm. According to other embodiments, the voids may be a variety of shapes, including triangular, rectangular, rhombus, trapezoidal, and polygonal, depending on the offset angle, the length, and the width.

In some embodiments, the offset angle, width, and length may be selected such that the resulting carrier comprises greater than about 10 voids/cm², across the surface of the carrier. In some embodiments, the offset angle, width, and length may be selected such that the resulting carrier comprises less than about 100 voids/cm², across the surface of the carrier. In some embodiments, the offset angle, width, and length may be selected such that the resulting carrier comprises from about 10 voids/cm² to about 100 voids/cm² across the surface of the carrier. In some embodiments, the offset angle, width, and length may be selected such that the resulting carrier comprises from about 15 voids/cm² to about 50 voids/cm² across the surface of the carrier. In some embodiments, the offset angle, width, and length may be selected such that the resulting carrier comprises from about 20 voids/cm² to about 30 voids/cm² across the surface of the carrier. In some embodiments, the offset angle, width, and length are selected such that the resulting carrier comprises about 25 voids/cm² across the surface of the carrier.

In some embodiments, the first and second strands may be oriented so that the voids extend all the way through the body of the carrier—i.e. from the first side of the carrier to the second side of the carrier. In other embodiments, the first and second strands may be oriented so that the voids only extend into the interior of the carrier from the first side or the second side. In either embodiment, the voids may have a depth ranging from about 0.1 mm to about 0.5 mm; alternatively a depth of about 0.25 mm—when measured from the first or second side of the carrier into the body of the carrier.

In some embodiments, the first linoleum composition forms a first linoleum layer. In some embodiments, the first linoleum layer has a thickness of from about 0.5 mm to about 5 mm; alternatively from about 0.75 mm to about 3 mm; alternatively from about 0.9 mm to about 1.1 mm.

In some embodiments, the second linoleum composition forms a second linoleum layer. In some embodiments, the second linoleum layer has a thickness of from about 0.5 mm to about 5 mm; alternatively from about 0.75 mm to about 3 mm; alternatively from about 1 mm to about 1.5 mm; alternatively from about 1.1 mm to about 1.4 mm.

In some embodiments, the first linoleum composition comprises: linoleum cement, a first organic filler, and a first inorganic filler. In some embodiments, the first linoleum composition comprises from about 30 wt. % to about 45 wt. % of linoleum cement, based on the total weight of the first linoleum composition. In some embodiments, the first linoleum composition comprises from about 40 wt. % of linoleum cement, based on the total weight of the first linoleum composition. In some embodiments, the first linoleum composition comprises from about 41 wt. % of linoleum cement, based on the total weight of the first linoleum composition.

The linoleum cement acts as a binder and comprises a drying oil and a resin, such as rosin, to act as a tackifier. In some embodiments, the drying oil comprises a fully or partially esterified fatty acid. In some embodiments, the drying oil comprises a polyunsaturated oil. In some embodiments, the drying oil comprises a dimer, a trimer or an oligomer obtained by reacting di, tri, and tetra-functional polyol compounds—such as glycerol or polyethylene glycol—with fatty acid compounds—such as palmitic acid, stearic acid, oleic acid, linoleic acid, pinolenic acid. In some embodiments, these drying oils include linseed oil, tall oil, soya oil, palm oil, castor oil, tung oil, olive oil, corn oil, canola oil, sunflower oil, peanut oil, camelina oil, lesquerella oil, vernonia oil, cardanol oil, coconut oil, karanja oil, jatropha oil, and a combination of two or more thereof. In some embodiments, the drying oil can be oxidized by atmospheric oxygen to form a dry solid. In some embodiments, the drying oil comprises linseed oil. In some embodiments, linseed oil is capable of drying faster than other oils.

In some embodiments the resin may be selected from gums and rosin. In some embodiments the cement may comprise from about 15 wt. % to about 35 wt. % of resin based on the total weight of the linoleum cement.

In some embodiments, the first linoleum composition comprises from about 20 wt. % to about 40 wt. % of a first inorganic filler, based on the total weight of the first linoleum composition. In some embodiments, the first linoleum composition comprises from about 20 wt. % to about 30 wt. % of a first inorganic filler, based on the total weight of the first linoleum composition. In some embodiments, the first linoleum composition comprises from about 30 wt. % to about 40 wt. % of a first inorganic filler, based on the total weight of the first linoleum composition. In some embodiments, the first linoleum composition comprises from about 25 wt. % to about 30 wt. % of a first inorganic filler, based on the total weight of the first linoleum composition. In some embodiments, the first linoleum composition comprises about 28 wt. % of a first inorganic filler, based on the total weight of the first linoleum composition.

Some embodiments provide that the first and/or second inorganic filler comprises particles having an average particle size of from about 0.5 μm to about 20 μm. Some embodiments provide that the first and/or second inorganic filler comprises particles having an average particle size of from about 1 μm to about 10 μm. Some embodiments provide that the first and/or second inorganic filler comprises particles having an average particle size of from about 1 μm to about 5 μm.

Some embodiments provide that the first and/or second inorganic filler comprises limestone (calcium carbonate), chalk, kaolin, silica, vermiculite, ball clay or bentonite, talc, mica, gypsum, perlite, titanium dioxide, sand, barium sulfate, dolomite, wollastonite, calcite, a pigment, zinc sulfate, or a combination of two or more thereof.

In some embodiments, the first linoleum composition comprises from about 15 wt. % to about 30 wt. % of a first organic filler, based on the total weight of the first linoleum composition. In some embodiments, the first linoleum composition comprises from about 20 wt. % to about 25 wt. % of a first organic filler, based on the total weight of the first linoleum composition. In some embodiments, the first linoleum composition comprises from about 18 wt. % to about 23 wt. % of the first organic filler, based on the total weight of the first linoleum composition. In some embodiments, the first linoleum composition comprises about 22 wt. % of the first organic filler, based on the total weight of the first linoleum composition.

Some embodiments provide that the first and/or second organic filler comprises a cellulosic, a polymeric material, a non-polymeric material, or a combination of two or more thereof. In some embodiments, the first and/or second organic filler may be a fibrous material or a particulate material. In some embodiments, the first and/or second organic filler comprises a cellulosic material selected from wood fibers, cork, wood shavings, wood flour, paper fibers, cotton linters, a combination of two or more thereof.

In some embodiments the wood flour may be made from a hardwood or a softwood. In some embodiments, the wood flour comprises particles having a particle size distribution as follows: <160 μm: 40-90%, and <80 μm 10-50%. In other embodiments, the wood flour comprises particles having a particle size distribution as follows: <160 μm 50-85%; and <80 μm 10-30%.

In some embodiments, the polymeric material may include polyolefin, and the non-polymeric material may include a hydrophobic material. In some embodiments, the hydrophobic material has a melting point below 100° C. In some embodiments, the non-polymeric material is selected from Montan wax; Carnauba wax; bee wax; paraffin; and a combination of two or more thereof.

In some embodiments, the non-polymeric material may be present in an amount ranging from about 0.1 wt. % to about 1 wt. % based on the total weight of the first and/or second linoleum composition. In some embodiments, the non-polymeric material may be present in an amount ranging from about 0.1 wt. % to about 0.6 wt. % based on the total weight of the first and/or second linoleum composition.

In some embodiments, the first and/or second linoleum composition may further comprise a flame retardant, such as aluminum trihydrate, ammonium phosphate or dipentaerythritol; a flame retardants which form a barrier layer, such as borates and aluminum polyphosphates; a solid inorganic flame retardant, and a flame retardant which forms an insulating layer; an intumescence agent, or a combination of two or more thereof. In some embodiments, halogenated organic compounds, such as chlorinated paraffin, or halogenated organic phosphorus compounds may be used as an additional flame retardant.

In some embodiments, solid inorganic flame retardants are understood to include, for example, inorganic compounds, such as aluminum oxide hydrates, borates, e.g., zinc borates, ammonium phosphate, antimony oxides, aluminum hydroxides, preferably aluminum trihydroxide, and magnesium hydroxide, aluminum hydroxide and magnesium hydroxide also being referred to as water-releasing flame retardants.

In some embodiments, the first and/or second linoleum composition further comprises a dispersant, a flocculant, a defoaming agent, a fungicide, a biocide, or a combination thereof. In some embodiments, the first and/or second linoleum composition further comprises a metal oxide, a metal hydroxide, or a combination thereof. In some embodiments, the metal oxide comprises zinc oxide.

In some embodiments, the second linoleum composition comprises linoleum cement, a second organic filler, and a second inorganic filler. In some embodiments, increasing the amount of organic and/or inorganic filler increases the dimensional stability of the resulting linoleum composition. In some embodiments, the enhanced dimensional stability is the result of reduced sensitivity to changes in moisture. In other words, as relative humidity of the surrounding environment increases or decreases, the linoleum composition is less likely to “dome” at high humidity and “curl” at low humidity.

In some embodiments, the second linoleum composition comprises from about 17.5 wt. % to about 70 wt. % of linoleum cement, based on the total weight of the second linoleum composition. In some embodiments, the second linoleum composition comprises from about 25 wt. % to about 45 wt. % of linoleum cement, based on the total weight of the second linoleum composition. In some embodiments, the second linoleum composition comprises from about 30 wt. % to about 40 wt. % of linoleum cement, based on the total weight of the second linoleum composition. In some embodiments, the second linoleum composition comprises about 35 wt. % of linoleum cement, based on the total weight of the second linoleum composition. In some embodiments, the second linoleum composition comprises about 36 wt. % of linoleum cement, based on the total weight of the second linoleum composition.

In some embodiments, the second linoleum composition comprises from about 10 wt. % to about 20 wt. % of the second inorganic filler, based on the total weight of the second linoleum composition. In some embodiments, the second linoleum composition comprises from about 12 wt. % to about 18 wt. % of the second inorganic filler, based on the total weight of the second linoleum composition. In some embodiments, the second linoleum composition comprises about 15 wt. % of the second inorganic filler, based on the total weight of the second linoleum composition. In some embodiments, the second linoleum composition comprises about 18 wt. % of the second inorganic filler, based on the total weight of the second linoleum composition.

In some embodiments, the second linoleum composition has a ratio of linoleum cement to the second inorganic filler ranging from about 1.75:1 to about 3.5:1. In some embodiments, the second linoleum composition has a ratio of linoleum cement to the second inorganic filler ranging from about 2:1 to about 2.5:1. In some embodiments, the second linoleum composition has a ratio of linoleum cement to the second inorganic filler ranging from about 2.1:1 to about 2.3:1. In some embodiments, the second linoleum composition has a ratio of linoleum cement to the second inorganic filler of about 2.25:1.

Some embodiments provide that the second linoleum composition comprises a second organic filler. In some embodiments, the second linoleum composition comprises from about 30 wt. % to about 45 wt. % of a second organic filler, based on the total weight of the second linoleum composition. In some embodiments, the second linoleum composition comprises from about 36 wt. % to about 41 wt. % of the second organic filler, based on the total weight of the second linoleum composition. In some embodiments, the second linoleum composition comprises about 38 wt. % of the second organic filler, based on the total weight of the second linoleum composition. In some embodiments, the second linoleum composition comprises about 40 wt. % of the second organic filler, based on the total weight of the second linoleum composition.

Some embodiments provide that the second linoleum composition comprises wood flour. In some embodiments, the second linoleum composition comprises from about 30 wt. % to about 45 wt. % of wood flour, based on the total weight of the second linoleum composition. In some embodiments, the second linoleum composition comprises from about 36 wt. % to about 41 wt. % of wood flour, based on the total weight of the second linoleum composition. In some embodiments, the second linoleum composition comprises about 38 wt. % of wood flour, based on the total weight of the second linoleum composition. In some embodiments, the second linoleum composition comprises about 40 wt. % of wood flour, based on the total weight of the second linoleum composition.

In some embodiments, the weight ratio of organic filler in the second linoleum composition to organic filler in the first linoleum composition is greater than 1.5:1. In some embodiments, the weight ratio of organic filler in the second linoleum composition to organic filler in the first linoleum composition is greater than 1.6:1. In some embodiments, the weight ratio of organic filler in the second linoleum composition to organic filler in the first linoleum composition is greater than 1.7:1. In some embodiments, the weight ratio of organic filler in the second linoleum composition to organic filler in the first linoleum composition is greater than 1.8:1.

In some embodiments, the weight ratio of wood flour in the second linoleum composition to wood flour in the first linoleum composition is greater than 1.5:1. In some embodiments, the weight ratio of wood flour in the second linoleum composition to wood flour in the first linoleum composition is greater than 1.6:1. In some embodiments, the weight ratio of wood flour in the second linoleum composition to wood flour in the first linoleum composition is greater than 1.7:1. In some embodiments, the weight ratio of wood flour in the second linoleum composition to wood flour in the first linoleum composition is greater than 1.8:1.

In some embodiments, the weight ratio of linoleum cement in the first linoleum composition to linoleum cement in the second linoleum composition is greater than 1.1:1. In some embodiments, the weight ratio of linoleum cement in the first linoleum composition to linoleum cement in the second linoleum composition is about 1.2:1.

Previous attempts to manufacture flooring surfaces comprising linoleum cement and filler have been problematic in that the flooring surfaces exhibited poor structural integrity and dimensional stability when the humidity of the surrounding environment fluctuates. The present inventors have discovered that by increasing the amount of organic and/or inorganic filler relative to the amount of linoleum cement, as well as controlling the type and size of each organic and/or inorganic filler, the resulting linoleum composition can withstand curling at low humidity (37% or less) and can withstand doming at high humidity (85%) without sacrificing the structural strength required for the final surface covering.

In some embodiments, the surface covering may further comprise a coating. In some embodiments, the coating is applied to the second linoleum composition. In some embodiments, the coating may perform as a wear layer. In some embodiments, the coating is UV curable, moisture curable or thermally curable. In some embodiments, the coating may be transparent and cured by UV radiation. In some embodiments, the coating provides good scratch and abrasion resistance and is sufficiently transparent to allow a print design to be visible from and through the topside of the product. In some embodiments, the coating comprises a UV curable polyurethane. In some embodiments, the coating comprises a moisture curable polyurethane.

In some embodiments, the coating may comprise particles that enhance dimensional stability and/or scratch resistance. In some embodiments, the particles are selected from chalk, barium sulfate, slate powder, silica, kaolin, quartz powder, talc, lignin, powdered glass, aluminum oxide, glass fibers, metal oxides, metal nitrides; and a combination of two or more thereof.

In some embodiments, the coating may have a thickness of from about 0.001 mm to 1 mm. In some embodiments, the coating may have a thickness of from about 0.005 mm to 0.5 mm. In some embodiments, the coating may have a thickness of from about 0.0075 mm to about 0.25 mm. In some embodiments, the coating may have a thickness of about 0.01 mm.

In some embodiments, the surface covering of the present invention may be made according to the following process. The first linoleum composition is produced by mixing the all components, such as the first linoleum cement, the first organic filler, and the first inorganic filler in a suitable mixing apparatus—e.g. a kneader, roll mill, or extruder, to form as homogenous a matrix as possible (mixed mass). In some embodiments, the first linoleum composition may further contain conventional additives, such as processing aids, antioxidants, UV stabilizers, slip agents and the like, which are selected as a function of the binder.

According to some embodiments, the homogenous matrix of the first linoleum composition is then fed into a roll mill (e.g., a calendar) and pressed onto a carrier typically at a temperature of typically 10° C. to 150° C. In some embodiments, the roll mill may be adjusted such that the resulting first linoleum composition/carrier has the desired layer thickness.

According to some embodiments, the second linoleum composition is produced separately and rolled into sheets and granulated. In some embodiments, the granulates are then mixed together and fed into the roll mill (e.g. a calendar) to produce a linoleum sheet of the second linoleum composition. The second linoleum sheet can then be pressed either directly onto the carrier/first linoleum composition or rolled onto the carrier/first linoleum composition through a roll mill.

The invention will be described in greater detail by way of specific examples. The following examples are offered for illustrative purposes and are not intended to limit the invention in any manner.

### EXAMPLES

### Example 1

Described in Table 1 (below) are the compositions of exemplary surface coverings of the present invention, along with the compositions of comparative surface coverings, which are commercially available products.

TABLE 1

| | Ex. I | Ex. II | Comp. Ex. I | Comp. Ex. II | Comp. Ex. III |
|---|---|---|---|---|---|
| Ingredients | Wt. % | | | | |
| First Linoleum Composition | | | | | |
| Linoleum cement | 41 | 41 | 49 | 40 | 38 |
| Wood flour | 22 | 22 | 29 | 32 | 30 |
| Limestone | 28 | 28 | 14 | 20 | 23 |
| Other | 9 | 9 | 8 | 8 | 9 |
| Second Linoleum Composition | | | | | |
| Linoleum cement | 36 | 35.1 | 44 | 35 | 38 |
| Wood flour | 38 | 40.4 | 37 | 47 | 30 |
| Limestone | 17 | 15.6 | 9 | 9 | 23 |
| ATH | 9 | 9 | 10 | 9 | 9 |
| Cement/Limestone Ratio | 2.12 | 2.25 | 4.75 | 3.89 | 1.63 |
| Second Organic Filler/First | 1.73 | 1.84 | 1.28 | 1.47 | 1 |
| Organic Filler Ratio | | | | | |

### Example 2

Surface coverings are mounted to a plate. A camera and video monitor are positioned to view the side of the surface covering and measure the vertical distance between the plate and the bottom of the surface covering. Surface coverings are conditioned for 2 days at each relative humidity level prior to measurement. For “ambient” measurements, surface coverings are removed from their shipping cartons and immediately evaluated for curl, without conditioning at a specific relative humidity.

Table 2 (below) describes the results of curl evaluations performed at various relative humidity levels for an exemplary surface covering of the present invention (Ex. II) and a comparative surface covering (Comp. Ex. II), which is commercially available.

TABLE 2

| | Relative Humidity | Average Curl |
|---|---|---|
| Surface Covering | (%) | (mils) |
| Ex. II | 35 | 10.6 |
| Comp. Ex. II | 35 | 17.3 |
| Ex. II | 50 | 5.1 |
| Comp. Ex. II | 50 | 8.1 |
| Ex. II | 80 | 3.2 |
| Comp. Ex. II | 80 | 4.3 |
| Ex. II | *ambient | 4.4 |
| Comp. Ex. II | *ambient | 26.1 |

*ambient = these surface coverings were evaluated immediately after removal from their respective boxes under ambient conditions.

The data described in Table 2 (above) demonstrates that surface coverings of the present invention resist curl to a greater extent across varying relative humidity levels, as compared to comparative surface coverings.

### Example 3

Table 3 (below) describes a comparison of dimensional stability (DS) performance between an exemplary surface covering of the present invention and a comparative surface covering. The surface coverings are conditioned; and dimensional stability for Across Machine Direction (AMD) and Machine Direction (MD) are measured according to the EN 669 standard.

TABLE 3

| | AMD DS | Difference between AMD DS and MD DS |
|---|---|---|
| Surface Covering | (%) | (%) |
| Ex. II | 0.056 | 0.012 |
| Comp. Ex. II | 0.066 | 0.028 |

The data described in Table 3 (above) demonstrates that exemplary surface coverings of the present invention provide significantly greater dimensional stability than comparative surface coverings, as evidenced by better AMD DS and a lesser difference between AMD DS and MD DS.

As those skilled in the art will appreciate, numerous changes and modifications may be made to the embodiments described herein, without departing from the spirit of the invention. It is intended that all such variations fall within the scope of the invention.

1. A surface covering comprising:
a carrier;
a first linoleum composition adjacent to the carrier comprising:
linoleum cement;
a first organic filler; and
a first inorganic filler; and
a second linoleum composition comprising:
linoleum cement;
a second organic filler; and
a second inorganic filler;
wherein the ratio of linoleum cement to the second inorganic filler in the second linoleum composition is from about 1.75:1 to about 3.5:1, and wherein the weight ratio of organic filler in the second linoleum composition to organic filler in the first linoleum composition is greater than 1.5:1.

2. The surface covering of claim 1, wherein the weight ratio of linoleum cement in the first linoleum composition to linoleum cement in the second linoleum composition is greater than 1.1:1.

3. The surface covering of claim 1, wherein the ratio of linoleum cement to the second inorganic filler in the second linoleum composition is from about 2.1:1 to about 2.3:1.

4. The surface covering of claim 1, wherein the second linoleum composition is adjacent to the first linoleum composition.

5. The surface covering of claim 1, wherein the second organic filler comprises particles of wood flour, the second organic filler having a particle size distribution wherein 40 to 90% of the particles are <160 μm and 10 to 50% of the particles are <80 μm.

6. The surface covering of claim 1, wherein the second linoleum composition comprises from about 25 wt. % to about 45 wt. % of linoleum cement based on the total weight of the second linoleum composition.

7. The surface covering of claim 1, wherein the second linoleum composition comprises from about 12 wt. % to about 18 wt. % of the second inorganic filler based on the total weight of the second linoleum composition.

8. The surface covering of claim 1, wherein the carrier comprises a binder and a material, wherein the binder comprising a thermoplastic resin selected from: polyethylene terephthalate, polyurethanes, polyolefin, epoxy, acrylic latex, phenolic resin, polyvinyl alcohol, melamine-formaldehyde, melamine-phenol-formaldehyde copolymer, and a combination of two or more thereof; and wherein the material is selected from: a synthetic fiber; a natural fiber; a woven fabric, a knitted fabric; and a combination of two or more thereof.

9. The surface covering of claim 1, further comprising a UV curable coating.

10. The surface covering of claim 1, wherein the second organic filler comprises limestone, and the second organic filler has a moisture content of less than about 10%.

11. The surface covering of claim 1, wherein the second linoleum composition further comprises a flame retardant, the flame retardant comprising aluminum trihydrate.

12. A surface covering comprising:
a carrier;
a first linoleum composition adjacent to the carrier comprising:
linoleum cement;
a first organic filler; and
a first inorganic filler; and
a second linoleum composition comprising:
linoleum cement;
a second organic filler; and
a second inorganic filler;
wherein the second organic filler comprises particles having a particle size distribution wherein 40 to 90% of the particles are <160 μm and 10 to 50% of the particles are <80 μm, and wherein the weight ratio of organic filler in the second linoleum composition to organic filler in the first linoleum composition is greater than 1.5:1.

13. The surface covering of claim 12, wherein the weight ratio of linoleum cement in the first linoleum composition to linoleum cement in the second linoleum composition is greater than 1.1:1.

14. The surface covering of claim 12 or claim 13, wherein the ratio of linoleum cement to the second inorganic filler in the second linoleum composition is from about 2.1:1 to about 2.3:1.

15. The surface covering of claim 12, wherein the second organic filler comprises wood flour.

16. The surface covering of claim 12, wherein the second linoleum composition comprises from about 25 wt. % to about 45 wt. % of linoleum cement based on the total weight of the second linoleum composition.

17. The surface covering of claim 12, wherein the second linoleum composition comprises from about 12 wt. % to about 18 wt. % of the second inorganic filler based on the total weight of the second linoleum composition.

18. The surface covering of claim 12, wherein the carrier comprises a binder and a material, wherein the binder comprising a thermoplastic resin selected from: polyethylene terephthalate, polyurethanes, polyolefin, epoxy, acrylic latex, phenolic resin, polyvinyl alcohol, melamine-formaldehyde, melamine-phenol-formaldehyde copolymer, and a combination of two or more thereof, and wherein the material is selected from: a synthetic fiber; a natural fiber; a woven fabric, a knitted fabric; and a combination of two or more thereof.

19. The surface covering of claim 12, wherein the second organic filler comprises limestone, and the second organic filler has a moisture content of less than about 10%.

20. A surface covering comprising:
a carrier;
a first linoleum composition adjacent to the carrier comprising:
linoleum cement;
a first organic filler; and
a first inorganic filler; and
a second linoleum composition adjacent to the first linoleum composition comprising:
linoleum cement in an amount ranging from about 25 wt. % to about 45 wt. % based on the total weight of the second linoleum composition;
a second organic filler; and
a second inorganic filler comprising limestone, the second inorganic filler being present in an amount ranging from about 12 wt. % to 18 wt. % based on the total weight of the second linoleum composition;
wherein weight ratio of linoleum cement in the first linoleum composition to linoleum cement in the second linoleum composition is greater than 1.1:1.
